(19) United States
(12) Patent Application Publication
(10) Pub. No.: US 2026/0349775 A1
(43) Pub. Date: Nov. 5, 2026

(54) Discrete Time Simulation (DTS) Based Infrastructure of Virtual Machines (VMs) in Distributed Cloud Environment

(71) Applicant: Bank of America Corporation, Charlotte, NC (US)

(72) Inventor: Vinod Maghnani, Gurugram (IN)

(21) Appl. No.: 19/194,263

(22) Filed: Apr. 30, 2025

(51) Int. Cl. G06F 9/455

(52) U.S. Cl. CPC G06F 9/45558; G06F 2009/4557

(57) ABSTRACT

A system and method manage virtual machines in a distributed cloud environment using discrete time simulation (DTS). A DTS framework initializes a registry, repository, and telemetric devices to monitor virtual machine parameters. Data fusion consolidates telemetry, logs, and heuristics, enabling temporal analysis of CPU, memory, and GPU usage. Predictive modeling forecasts resource needs, while auto-coded snapshots are generated and deployed to centralized and target clusters. Utilities provide prognosis, health monitoring against thresholds, maintenance actions, diagnosis of unused grids, and security restrictions. A scheduler ensures periodic execution, optimizing resource allocation across deployment lanes. Integration with orchestration tools supports containerized environments, and distributed storage enhances scalability. This invention automates virtual machine management, leveraging simulation for efficiency and adaptability in cloud infrastructures.

### TECHNICAL FIELD

The inventions disclosed herein pertain to systems and methods for managing and simulating computational resources in a networked environment, specifically focusing on the allocation, deployment, and maintenance of virtual machines within a distributed cloud infrastructure. The technology involves the use of discrete time simulation to model and predict the performance and resource needs of virtual machines, enabling automated generation of configuration snapshots and deployment processes. This encompasses the design and implementation of software frameworks that integrate data processing, system parameter analysis, and predictive modeling to enhance the efficiency of virtualized computing environments. Additionally, the inventions address the virtualization of hardware resources and the systematic consolidation of data and event logs to support real-time monitoring and optimization of distributed computing systems.

### DESCRIPTION OF THE RELATED ART

There are significant challenges in the management of virtual machines within distributed cloud environments. In modern computing, organizations rely on distributed cloud systems to handle various applications across multiple deployment lanes, such as development, testing, and production. These environments often host numerous virtual machines, each tasked with executing specific codes and configurations to support operational processes. However, a persistent issue arises from the lack of a standardized approach to assess the infrastructure requirements prior to deploying these virtual machines, leading to inefficiencies that impact system performance and resource allocation.

One major difficulty stems from the absence of a mechanism to evaluate the precise needs of virtual machines before their snapshots are created. Organizations typically establish virtual machines to support new departments or processes within a distributed cloud setup. Without a clear understanding of the necessary resources, such as the number of machines or the extent of code deployment, planning becomes imprecise. This often results in either an overestimation of resources, where more virtual machines are provisioned than needed, or an underestimation, where insufficient resources fail to meet operational demands. Both scenarios lead to wasted computational capacity or degraded performance, respectively, complicating the effective operation of the cloud environment.

Another challenge lies in the manual processes currently employed to generate snapshots for virtual machines. Administrators must manually code instructions and execute them to create these snapshots, a task that lacks insight into future requirements. For instance, a department serving a specific user base may see that base grow substantially over time, yet the initial virtual machine setup does not account for this expansion. The manual approach fails to incorporate predictive analysis, leaving systems unprepared for increases in data volume or processing needs, which in turn disrupts scalability and responsiveness in the distributed cloud infrastructure.

The inability to anticipate future resource demands exacerbates operational inefficiencies. In a distributed cloud environment, virtual machines must adapt to fluctuating workloads, such as a sudden increase in users or data processing tasks. Without a systematic way to analyze historical patterns or project future trends, administrators cannot determine how many additional virtual machines might be necessary or how existing ones should be adjusted. This gap in foresight leads to frequent reconfiguration efforts, downtime, or the deployment of unnecessary resources, all of which hinder the seamless functioning of the cloud system.

Furthermore, the lack of automated tools for snapshot creation and deployment compounds these issues. In traditional setups, the process of promoting snapshots to a centralized location and integrating them into the deployment pipeline requires multiple manual steps. This not only consumes time but also introduces the potential for human error, such as incorrect configurations or missed updates. As a result, the distributed cloud environment suffers from delays in provisioning virtual machines, reducing the agility that such systems are intended to provide to organizations relying on rapid deployment capabilities.

An additional problem emerges from the fragmented management of virtual machine resources. In distributed cloud setups, data and event logs associated with virtual machines are often scattered across different segments of the infrastructure. This fragmentation slows down processing, as accessing and consolidating this information takes additional time and computational effort. Without a unified approach to managing these resources, the system struggles to maintain optimal performance, especially as the volume of data grows, further straining the virtual machines and the broader cloud environment.

The absence of real-time monitoring and maintenance capabilities presents yet another obstacle. Virtual machines in a distributed cloud system require ongoing oversight to ensure they operate at peak efficiency. However, current practices do not provide a framework for continuously tracking the state of these machines or identifying underutilized resources. This lack of visibility means that issues such as overloaded machines or unused capacity go unnoticed, leading to suboptimal resource distribution and potential system bottlenecks that affect overall performance.

Security concerns also arise due to the unstructured management of virtual machines. In distributed cloud environments, ensuring that only authorized entities access specific resources is paramount. Yet, without a mechanism to diagnose unused segments or enforce proper access controls, the system remains vulnerable to unauthorized use or inefficient allocation. This exposes the infrastructure to risks that could compromise data integrity or disrupt operations, a problem that grows more pressing as the scale of the cloud environment expands.

The cumulative effect of these challenges is a distributed cloud environment that struggles to balance efficiency, scalability, and reliability. Organizations face difficulties in aligning their virtual machine infrastructure with actual needs, resulting in either excess capacity that wastes resources or insufficient capacity that hampers performance. The manual, reactive nature of current practices limits the ability to proactively address these issues, leaving systems ill-equipped to handle the dynamic demands of modern computing workloads in a distributed setting.

The long felt and unmet need for a solution to these problems has persisted as distributed cloud environments have become integral to organizational operations. For years, the industry has sought a way to move beyond manual, ad hoc approaches to virtual machine management, yearning for a method that provides predictive insight, automation, and comprehensive resource oversight. Despite advancements in cloud technology, no standard framework has emerged to address the precise determination of infrastructure needs, the automated creation and deployment of snapshots, or the continuous monitoring and optimization of virtual machines, leaving a gap that this invention seeks to fill.

### SUMMARY OF THE INVENTION

The inventions disclosed herein introduce a comprehensive system and methodology for managing virtual machines within a distributed cloud environment through the application of discrete time simulation. This approach leverages a data-driven machine learning model to analyze and predict the time evolution of system parameters associated with virtual machines. By simulating the behavior of these machines over discrete time intervals, the system generates insights into resource needs and operational dynamics, enabling a more structured and efficient deployment process across various lanes, including development, system integration testing, unit testing, and production environments.

A central component of this invention is the discrete time simulation framework, which functions as a simulator for virtual machines. This simulator automates the creation of snapshots by producing code instructions based on analyzed data, eliminating the need for manual coding. Once generated, these snapshots, accompanied by metadata files, are promoted to a centralized repository. This allows administrators to deploy virtual machines into the distributed cloud environment with a single action, streamlining the process and ensuring that configurations align with the specific requirements of each deployment lane.

Within this framework, virtual machines are treated as entities akin to Internet of Things devices. This conceptualization enables the system to incorporate three distinct operational blocks. The first block focuses on data fusion and processing, where data from various sources, such as event logs and application heuristics, is consolidated and analyzed. The second block determines the temporal evolution of system parameters, including hardware-related metrics like CPU usage, memory allocation, and GPU performance. The third block uses this information to make predictions about future resource needs, providing a forward-looking perspective on infrastructure planning.

The invention also includes utilities that extend beyond snapshot creation and deployment. One such utility is prognosis, which involves forecasting the operational state of virtual machines based on historical and real-time data. Another utility is health monitoring, which continuously tracks the performance and utilization of virtual machines to identify inefficiencies or potential failures. Additionally, a maintenance utility ensures that resources are optimized and issues are addressed proactively, enhancing the longevity and reliability of the virtual machine infrastructure.

A key aspect of this invention is the virtualization of virtual machines through systematic data consolidation. By aggregating data, event logs, and other parameters, the system creates a digital time simulator that models the behavior of virtual machines in a distributed cloud environment. This simulator not only predicts resource requirements but also optimizes the allocation of computational assets, reducing latency and improving processing efficiency. The consolidation process ensures that fragmented data across the infrastructure is unified, enabling faster access and analysis.

The workflow of this invention is integrated into a high-level architecture that outlines the interaction between various components. Virtual machines interface with hardware telemetric devices to gather real-time data on system performance. This data feeds into the discrete time simulation framework, where it undergoes fusion and processing. The system then validates this data temporally, assessing how parameters evolve over time, and uses the results to forecast behavioral patterns and predict future needs, such as the number of virtual machines required or the extent of code deployment.

One unique feature of this invention is the automated generation of snapshot instructions. The system analyzes the software versions and project specifications needed for deployment, producing tailored code that reflects the environment-specific configurations. This auto-coding capability extends across all deployment lanes, ensuring consistency and accuracy without manual intervention. The snapshots created through this process are stored with metadata in a centralized location, providing a reference point for future adjustments or predictions.

The discrete time simulation framework also supports advanced resource management. For example, it can extrapolate GPU usage and memory needs in machine learning contexts, offering precise predictions for computationally intensive tasks. This capability allows the system to adapt to diverse workloads, ensuring that virtual machines are equipped to handle specialized requirements without over-provisioning or under-utilization of resources.

Beyond snapshot determination, the invention provides additional functionalities for managing virtual machines. It identifies unused grids within the infrastructure, diagnosing segments that are underutilized and reallocating resources accordingly. This feature enhances efficiency by ensuring that computational capacity is fully leveraged. The system also incorporates security services, restricting access to privileged entities and safeguarding the integrity of the distributed cloud environment.

The architecture of this invention includes a server that acts as an administrative hub, interacting with the discrete time simulators to manage infrastructure requirements. Virtual machines are onboarded through a process that evaluates hardware telemetric data and system parameters before integration into the cloud environment. During onboarding, the system captures snapshots and metadata, storing them in a centralized repository for future reference and predictive analysis.

The predictive modeling aspect of this invention relies on the temporal validation of data. By analyzing how system parameters change over time, the discrete time simulation framework forecasts the number of virtual machines needed or the adjustments required for existing ones. This predictive capability is dynamic, running continuously to adapt to shifts in data volume or processing demands, ensuring that the infrastructure remains aligned with operational needs.

The invention supports all stages of the software development lifecycle, from development to production. Environment-specific configuration templates are generated and applied across these stages, ensuring that virtual machines are consistently configured regardless of the deployment lane. This uniformity reduces errors and simplifies the transition of applications through testing and into operational use.

Another distinctive element is the real-time monitoring of virtual machines. The system tracks characteristics such as event logs and application heuristics, providing a comprehensive view of performance. This ongoing oversight allows administrators to identify and address issues as they arise, maintaining optimal operation without disrupting workflows. The monitoring process is integrated with the maintenance utility, enabling proactive resource management.

The discrete time simulation framework also enhances security by diagnosing unused grids and enforcing access controls. By identifying segments of the infrastructure that are not fully utilized, the system can reallocate resources or restrict access to prevent unauthorized use. This dual focus on efficiency and security ensures that the distributed cloud environment remains robust and protected against potential vulnerabilities.

The invention's ability to consolidate data and event logs in real-time is a significant advancement. Rather than relying on fragmented data sources, the system unifies this information, reducing processing delays and improving the accuracy of simulations. This consolidation supports the digital time simulator, which models virtual machine behavior and predicts future requirements with greater precision.

The auto-coding mechanism is dynamic, adapting to changes in software versions or project needs. This adaptability ensures that snapshots remain relevant as the distributed cloud environment evolves, reducing the need for manual updates. The system also dumps snapshots, metadata, and configuration files into target clusters, streamlining deployment and maintaining a centralized record for administrative purposes.

The invention provides a holistic approach to virtual machine management by integrating data fusion, system parameter analysis, and predictive modeling. This comprehensive framework allows organizations to optimize their distributed cloud infrastructure, ensuring that virtual machines are deployed efficiently and maintained effectively. The system's utilities, such as prognosis and health monitoring, add layers of functionality that enhance operational reliability.

The architecture diagram accompanying this invention illustrates the flow of data from servers to discrete time simulators and virtual machines. It highlights the centralized repository's role in storing snapshots and metadata, as well as the interaction between hardware telemetric devices and the simulation framework. This visual representation underscores the interconnectedness of the system's components and their collective contribution to infrastructure management.

The invention's emphasis on automation, prediction, and real-time oversight distinguishes it from existing approaches. By treating virtual machines as smart entities and leveraging discrete time simulation, the system achieves a level of precision and efficiency that manual processes cannot match. This innovation addresses the complexities of distributed cloud environments, offering a scalable solution for organizations with diverse computing needs.

In light of the preceding discussion, the following identifies various sample embodiments of the present disclosure to establish a basic understanding of its various components. This summary is not exhaustive, nor does it limit the illustrative embodiments of the inventions described in this document. It is not intended to identify the most essential features or steps of the disclosure, nor to define its scope. Instead, as would be recognized by someone skilled in the field, it seeks to introduce certain concepts of the disclosure in a clear and simple way, acting as a preface to the more detailed explanation that follows. Throughout this application, the specification offers thorough written descriptions of the inventions, including exemplary, non-exhaustive, and non-limiting methods and processes for making and using the inventions. These descriptions are expressed in complete, clear, concise, and precise terms, allowing those skilled in the art to implement and utilize the inventions without undue experimentation, while also indicating the preferred method envisioned for carrying out the inventions.

In some arrangements, a method for managing virtual machines in a distributed cloud environment using discrete time simulation involves several steps performed by specific components. A discrete time simulation (DTS) framework initializes a system that includes a virtual machine registry, a snapshot repository, and telemetric devices. The DTS framework configures the telemetric devices to monitor hardware parameters of a virtual machine. A data fusion processor within the DTS framework processes data fusion for the virtual machine by consolidating event logs, application heuristics, and telemetry data into fused data.

In some arrangements, continuing this method, a system parameter analyzer within the DTS framework analyzes the temporal evolution of system parameters, which include CPU usage, memory usage, and GPU usage, based on the fused data. A prediction engine within the DTS framework predicts the future resource needs of the virtual machine over a time interval using these system parameters. A snapshot generator within the DTS framework generates a snapshot for the virtual machine by auto-coding instructions based on software requirements, project versions, and a configuration template specific to a deployment lane.

In some arrangements, further steps include a deployment module within the DTS framework deploying the snapshot, along with metadata, to a centralized repository and a target cluster in the distributed cloud environment. A prognosis utility within the DTS framework forecasts a future operational state of the virtual machine based on the fused data. A health monitoring utility within the DTS framework monitors the health status of the virtual machine by comparing the system parameters to predefined thresholds.

In some arrangements, the method concludes with a maintenance utility within the DTS framework maintaining the virtual machine by executing actions when the health status exceeds the predefined thresholds. A grid diagnostic module within the DTS framework diagnoses unused grids in the virtual machine by identifying low CPU and memory usage. A security module within the DTS framework restricts access to the unused grids to privileged entities. The DTS framework repeats the processing, predicting, generating, deploying, forecasting, monitoring, maintaining, diagnosing, and restricting steps periodically to manage the virtual machine dynamically.

In some arrangements, a method builds upon the previously described method by specifying additional details. The DTS framework configures the telemetric devices to monitor hardware parameters of a virtual machine by connecting each telemetric device to the virtual machine and starting real-time monitoring of the hardware parameters.

In some arrangements, a method extends the prior method with further refinements. The data fusion processor within the DTS framework processes data fusion for the virtual machine by consolidating event logs, application heuristics, and telemetry data into fused data, aggregating the event logs from multiple sources, and extracting trends from the application heuristics.

In some arrangements, a method enhances the earlier described method with additional specifics. The prediction engine within the DTS framework predicts future resource needs of the virtual machine over a time interval using the system parameters and extrapolates the system parameters to estimate a number of additional virtual machines required for the distributed cloud environment.

In some arrangements, a method adds precision to the snapshot generation process of the prior method. The snapshot generator within the DTS framework generates a snapshot for the virtual machine by auto-coding instructions based on software requirements, project versions, and a configuration template specific to a deployment lane, with the auto-coding instructions being produced in a programming language compatible with the target cluster.

In some arrangements, a method refines the deployment process from the earlier method. The deployment module within the DTS framework deploys the snapshot with metadata to a centralized repository and the target cluster in the distributed cloud environment by uploading the snapshot to the centralized repository and executing the auto-coding instructions in the target cluster with a single command.

In some arrangements, a method further details the forecasting step of the prior method. The prognosis utility within the DTS framework forecasts a future operational state of the virtual machine based on the fused data, including generating a 30-day forecast and assessing risks based on current system parameters.

In some arrangements, a method provides specifics to the monitoring process of the earlier method. The health monitoring utility within the DTS framework monitors a health status of the virtual machine by comparing the system parameters to predefined thresholds, including checking the CPU usage against an 80% threshold, the memory usage against a 90% threshold, and the GPU usage against an 85% threshold.

In some arrangements, a method adds detail to the diagnosing step of the prior method. The grid diagnostic module within the DTS framework diagnoses unused grids in the virtual machine by identifying low CPU and memory usage, specifically identifying the virtual machine with CPU usage below 10% and memory usage below 10%.

In some arrangements, a method enhances the security aspect of the earlier method. The security module within the DTS framework restricts access to the unused grids to privileged entities by updating an access policy of the virtual machine to limit interaction to privileged entities only.

In some arrangements, a comprehensive method for managing virtual machines in a distributed cloud environment using discrete time simulation incorporates extensive steps. A discrete time simulation (DTS) framework initializes a system including a virtual machine registry, a snapshot repository, and telemetric devices. The DTS framework configures the telemetric devices to monitor hardware parameters of a virtual machine by connecting each telemetric device to the virtual machine and starting real-time monitoring of the hardware parameters.

In some arrangements, this comprehensive method continues with a data fusion processor within the DTS framework processing data fusion for the virtual machine by consolidating event logs, application heuristics, and telemetry data into fused data, aggregating the event logs from multiple sources, and extracting trends from the application heuristics. A system parameter analyzer within the DTS framework analyzes the temporal evolution of system parameters including CPU usage, memory usage, and GPU usage based on the fused data.

In some arrangements, further steps involve a prediction engine within the DTS framework predicting future resource needs of the virtual machine over a time interval using the system parameters and extrapolating the system parameters to estimate a number of additional virtual machines required for the distributed cloud environment. A snapshot generator within the DTS framework generates a snapshot for the virtual machine by auto-coding instructions based on software requirements, project versions, and a configuration template specific to a deployment lane, with the auto-coding instructions being produced in a programming language compatible with a target cluster.

In some arrangements, the method progresses with a deployment module within the DTS framework deploying the snapshot with metadata to a centralized repository and the target cluster in the distributed cloud environment by uploading the snapshot to the centralized repository and executing the auto-coding instructions in the target cluster with a single command. A prognosis utility within the DTS framework forecasts a future operational state of the virtual machine based on the fused data, including generating a 30-day forecast and assessing risks based on current system parameters.

In some arrangements, additional actions include a health monitoring utility within the DTS framework monitoring a health status of the virtual machine by comparing the system parameters to predefined thresholds, including checking the CPU usage against an 80% threshold, the memory usage against a 90% threshold, and the GPU usage against an 85% threshold. A maintenance utility within the DTS framework maintains the virtual machine by executing actions when the health status exceeds the predefined thresholds.

In some arrangements, the method further entails a grid diagnostic module within the DTS framework diagnosing unused grids in the virtual machine by identifying low CPU and memory usage, specifically identifying the virtual machine with CPU usage below 10% and memory usage below 10%. A security module within the DTS framework restricts access to the unused grids to privileged entities by updating an access policy of the virtual machine to limit interaction to privileged entities only.

In some arrangements, concluding this comprehensive method, the DTS framework repeats the processing, predicting, generating, deploying, forecasting, monitoring, maintaining, diagnosing, and restricting steps periodically to manage the virtual machine dynamically. The DTS framework stores the fused data and snapshots in a distributed repository across multiple geographic regions. The DTS framework integrates the deployment module with an external cloud orchestration tool to deploy the snapshot into a containerized environment.

In some arrangements, a system for managing virtual machines in a distributed cloud environment using discrete time simulation comprises multiple components with specific functions. A discrete time simulation (DTS) framework initializes a virtual machine registry storing virtual machine data, a snapshot repository storing snapshots, and telemetric devices monitoring hardware parameters. A plurality of telemetric devices monitors hardware parameters including CPU usage, memory usage, and GPU usage of a virtual machine in real time.

In some arrangements, this system includes a data fusion processor within the DTS framework that consolidates event logs, application heuristics, and telemetry data from the telemetric devices into fused data for the virtual machine. A system parameter analyzer within the DTS framework analyzes the temporal evolution of system parameters including the CPU usage, the memory usage, and the GPU usage based on the fused data. A prediction engine within the DTS framework predicts future resource needs of the virtual machine over a time interval using the system parameters.

In some arrangements, further components consist of a snapshot generator within the DTS framework that generates a snapshot for the virtual machine by auto-coding instructions based on software requirements, project versions, and a configuration template specific to a deployment lane. A deployment module within the DTS framework deploys the snapshot with metadata to a centralized repository and a target cluster in the distributed cloud environment. A prognosis utility within the DTS framework forecasts a future operational state of the virtual machine based on the fused data.

In some arrangements, the system also features a health monitoring utility within the DTS framework that monitors a health status of the virtual machine by comparing the system parameters to predefined thresholds. A maintenance utility within the DTS framework maintains the virtual machine by executing actions when the health status exceeds the predefined thresholds. A grid diagnostic module within the DTS framework diagnoses unused grids in the virtual machine by identifying low CPU and memory usage.

In some arrangements, concluding the system's components, a security module within the DTS framework restricts access to the unused grids to privileged entities. A scheduler within the DTS framework periodically activates the data fusion processor, the prediction engine, the snapshot generator, the deployment module, the prognosis utility, the health monitoring utility, the maintenance utility, the grid diagnostic module, and the security module to manage the virtual machine dynamically.

In some arrangements, a system builds upon the previously described system with added detail. The plurality of telemetric devices connects to the virtual machine and starts real-time monitoring of the hardware parameters upon configuration by the DTS framework.

In some arrangements, a system refines the prior system's data fusion process. The data fusion processor aggregates the event logs from multiple sources and extracts trends from the application heuristics to produce the fused data.

In some arrangements, a system enhances the prediction capabilities of the earlier system. The prediction engine extrapolates the system parameters to estimate a number of additional virtual machines required for the distributed cloud environment.

In some arrangements, a system specifies the snapshot generation process of the prior system. The snapshot generator produces the auto-coding instructions in a programming language compatible with the target cluster.

In some arrangements, a system details the deployment mechanism of the earlier system. The deployment module uploads the snapshot to the centralized repository and executes the auto-coding instructions in the target cluster with a single command.

In some arrangements, a system adds precision to the forecasting function of the prior system. The prognosis utility generates a 30-day forecast of the future operational state and assesses risks based on current system parameters.

In some arrangements, a system refines the health monitoring process of the earlier system. The health monitoring utility checks the CPU usage against an 80% threshold, the memory usage against a 90% threshold, and the GPU usage against an 85% threshold to determine the health status.

In some arrangements, a highly detailed system extends the prior system with comprehensive specifics. The grid diagnostic module identifies the virtual machine with the CPU usage below 10% and the memory usage below 10% to diagnose the unused grids. The security module updates an access policy of the virtual machine to limit interaction with the unused grids to privileged entities only. The scheduler activates the data fusion processor, the prediction engine, the snapshot generator, the deployment module, the prognosis utility, the health monitoring utility, the maintenance utility, the grid diagnostic module, and the security module on an hourly basis. The DTS framework stores the fused data and the snapshots in a distributed repository spanning multiple geographic regions to reduce latency. The deployment module integrates with an external cloud orchestration tool to deploy the snapshot into a containerized environment compatible with the distributed cloud environment.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

BRIEF DESCRIPTION OF DRAWINGS

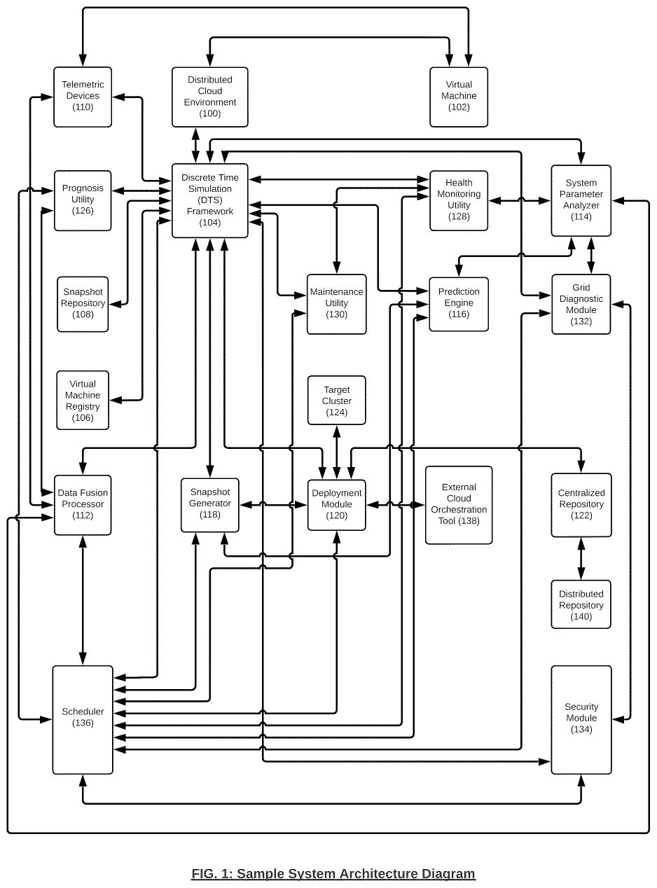

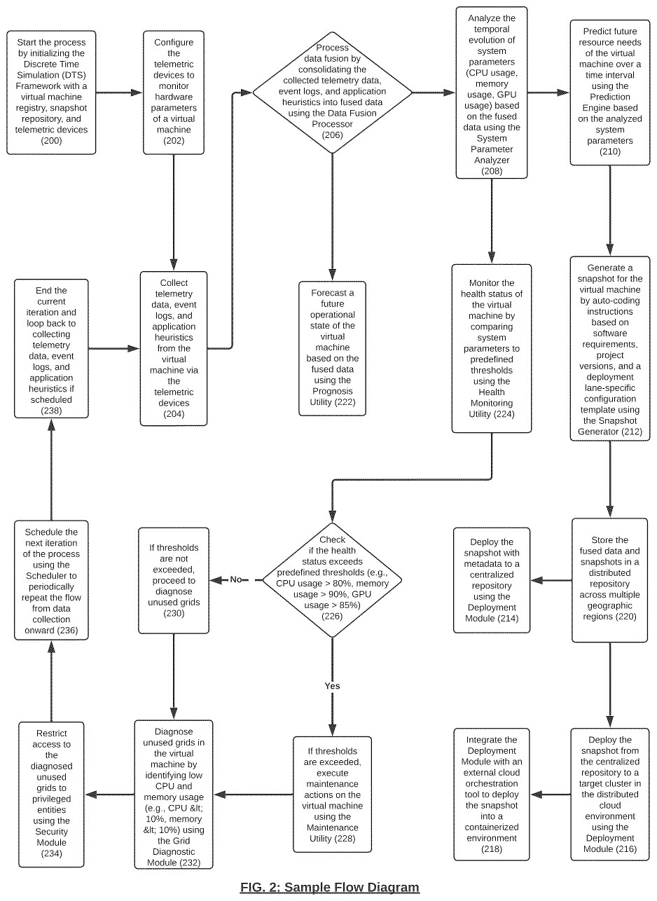

FIG. 1 is an exemplary system architecture diagram in accordance with one or more embodiments disclosed herein that illustrates the arrangement and interaction of components within a distributed cloud environment for managing virtual machines using discrete time simulation. It depicts the flow of data and control between various modules and utilities to enable dynamic resource management and optimization.

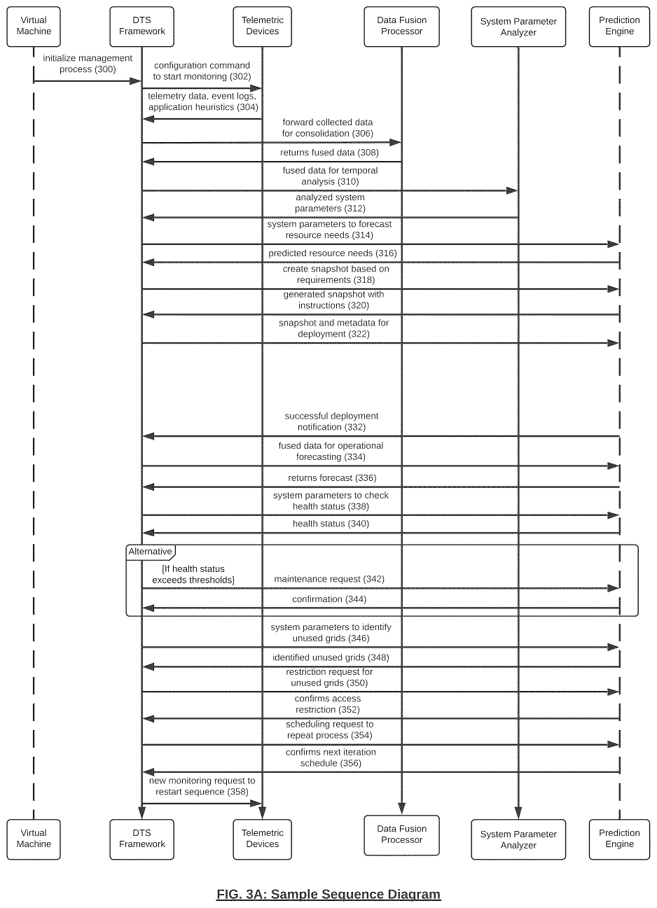

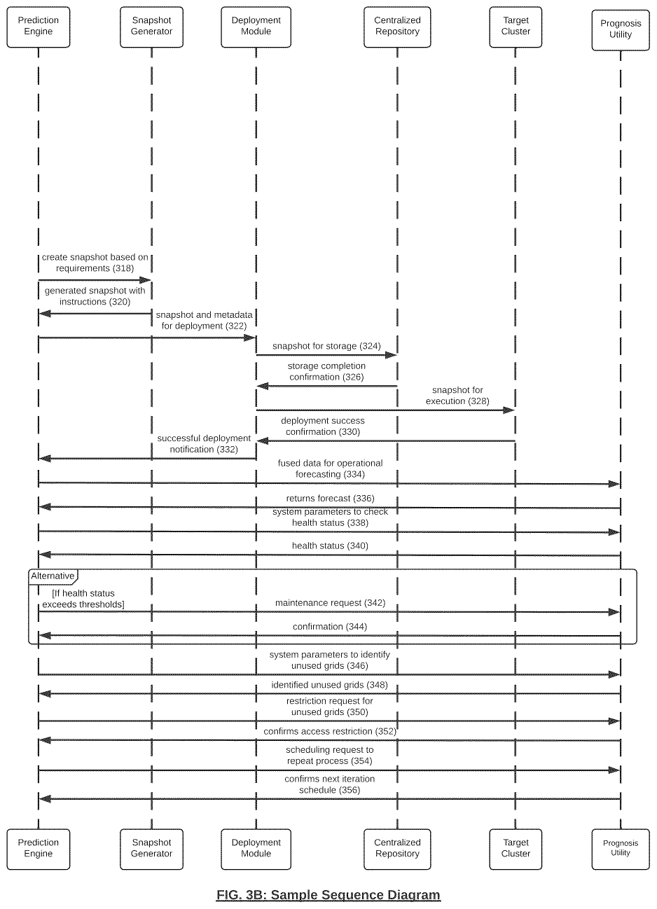

FIG. 2 is an exemplary flow diagram in accordance with one or more embodiments disclosed herein that illustrates the sequential process of managing virtual machines in a distributed cloud environment using discrete time simulation. It outlines the steps from initialization to dynamic management, including data processing, prediction, deployment, and maintenance activities.

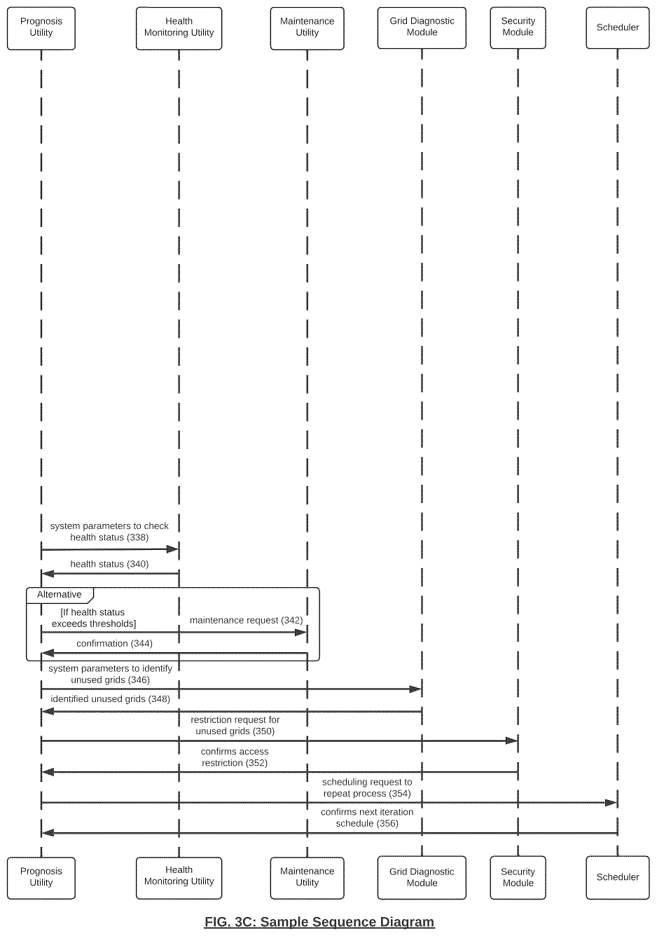

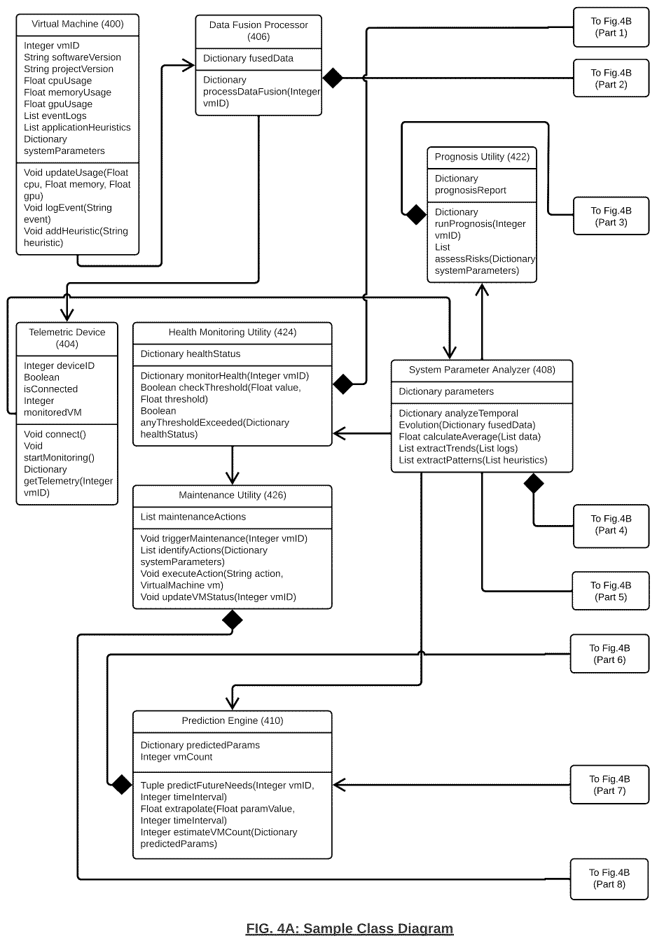

FIGS. 3A-3C are collectively an exemplary sequence diagram in accordance with one or more embodiments disclosed herein that illustrates the interactions between various actors involved in managing virtual machines in a distributed cloud environment using discrete time simulation. It details the step-by-step communication flow from initialization to dynamic management, highlighting the coordination of data and actions across system components.

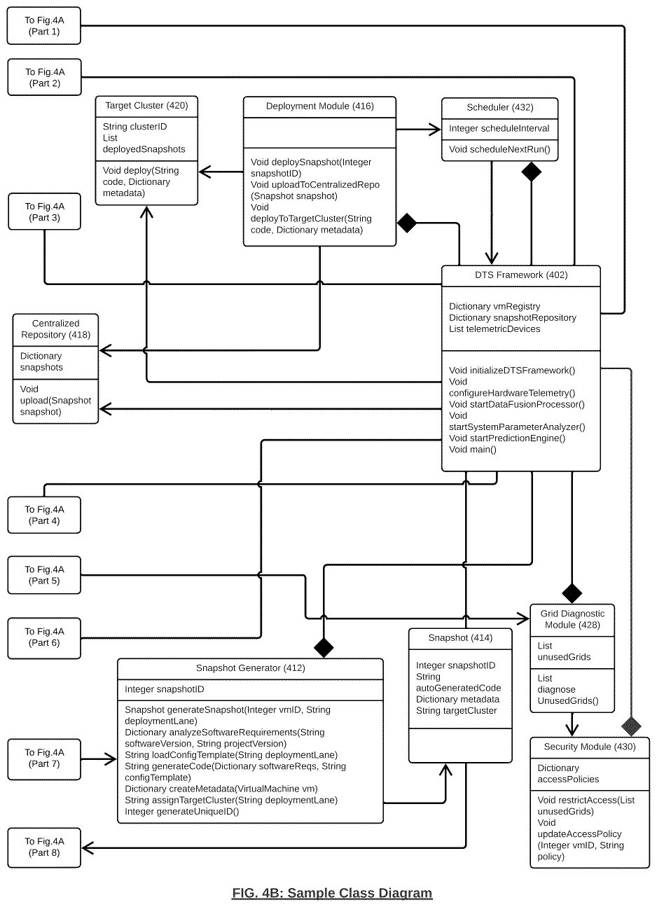

FIGS. 4A-4B are collectively an exemplary class diagram in accordance with one or more embodiments disclosed herein that illustrates the object-oriented structure and relationships among classes involved in managing virtual machines in a distributed cloud environment using discrete time simulation. It details the attributes and methods of each class, as well as their interconnections, providing a blueprint for implementing the system's software architecture.

### DETAILED DESCRIPTION

The invention centers on a sophisticated system and methodology for managing virtual machines within a distributed cloud environment, utilizing discrete time simulation as its foundational approach. This technology addresses the complexities of virtual machine deployment and maintenance by employing a data-driven framework that simulates system behavior over discrete time intervals. By doing so, it provides a predictive and automated mechanism to optimize resource allocation and operational efficiency across various deployment lanes, such as development, testing, and production environments, ensuring that virtual machines are configured and scaled according to real-time and future needs.

At the core of this invention is the Discrete Time Simulation (DTS) Framework, a comprehensive structure that integrates multiple components to manage virtual machines dynamically. This framework treats virtual machines as entities similar to Internet of Things devices, enabling a modular approach with distinct operational blocks. These blocks include data fusion and processing, system parameter analysis, and predictive modeling, each contributing to a holistic management strategy that transcends traditional manual methods, offering a scalable solution for distributed cloud infrastructures.

The data fusion and processing component consolidates diverse data sources, such as event logs, application heuristics, and telemetry data from hardware devices, into a unified dataset. This process ensures that all relevant information about a virtual machine's performance and usage is available for analysis, providing a solid foundation for subsequent steps. By aggregating this data, the system can maintain an accurate and up-to-date representation of the virtual machine's state, which is essential for effective simulation and decision-making.

Following data fusion, the system parameter analyzer evaluates the temporal evolution of critical metrics, including CPU usage, memory consumption, and GPU utilization. This analysis tracks how these parameters change over time, offering insights into performance trends and resource demands. Such temporal analysis is pivotal for understanding the dynamic nature of virtual machine workloads, allowing the system to adapt to varying operational conditions within the distributed cloud environment.

The prediction engine leverages the analyzed system parameters to forecast future resource needs over specified time intervals. By employing machine learning techniques, this component estimates the number of virtual machines required or the adjustments needed for existing ones, based on historical and current data trends. This predictive capability enables proactive resource planning, reducing the risk of over-provisioning or under-utilization, which are common challenges in cloud management.

A standout feature of the invention is the snapshot generator, which automates the creation of virtual machine snapshots through auto-coding. This process generates configuration instructions tailored to software requirements, project versions, and specific deployment lanes, eliminating manual coding efforts. The resulting snapshots, complete with metadata, are stored in a centralized repository, facilitating rapid deployment to target clusters with a single command, enhancing deployment efficiency significantly.

The deployment module manages the distribution of these snapshots, uploading them to a centralized repository and executing them within target clusters in the distributed cloud environment. This streamlined deployment process ensures that virtual machines are instantiated quickly and consistently across various lanes, supporting seamless transitions from development to production. Integration with external cloud orchestration tools further extends this capability, allowing deployment into containerized environments for added flexibility.

Beyond initial deployment, the invention includes utilities for ongoing management, starting with the prognosis utility. This component forecasts the future operational state of virtual machines, providing long-term insights based on fused data. Such forecasts help administrators anticipate potential issues or capacity needs, enabling strategic planning that aligns with organizational goals in the distributed cloud setting.

The health monitoring utility continuously assesses virtual machine performance by comparing system parameters against predefined thresholds, such as 80% CPU usage or 90% memory usage. This real-time monitoring identifies when a virtual machine exceeds operational limits, triggering alerts or actions to maintain stability. By keeping a constant watch on health status, the system ensures that performance remains optimal across the infrastructure.

When health thresholds are breached, the maintenance utility steps in to execute corrective actions, such as reallocating resources or restarting services. This automated maintenance preserves virtual machine functionality without requiring manual intervention, enhancing reliability. The utility's ability to respond promptly to monitoring alerts underscores the invention's focus on proactive management.

Another innovative aspect is the grid diagnostic module, which identifies unused or underutilized segments within virtual machines, such as those with CPU and memory usage below 10%. This diagnosis helps optimize resource allocation by pinpointing areas of inefficiency, allowing for reallocation or decommissioning of unnecessary capacity. This feature contributes to cost savings and improved resource utilization in the cloud environment.

The security module complements the grid diagnostic module by restricting access to these unused grids to privileged entities only. By updating access policies, it ensures that underutilized resources are protected from unauthorized use, bolstering the security of the distributed cloud infrastructure. This dual focus on efficiency and security is a unique strength of the invention.

The scheduler orchestrates the periodic execution of these processes, ensuring that data collection, analysis, prediction, deployment, and maintenance occur at regular intervals, such as hourly. This continuous cycle maintains the system's responsiveness to changing conditions, making it a dynamic management tool. The scheduler's role in coordinating these activities ties the entire framework together into a cohesive operation.

The invention's architecture supports scalability and adaptability, with components interconnected to facilitate data flow and control. The DTS Framework serves as the central hub, linking internal modules like the data fusion processor and prediction engine with external entities like repositories and clusters. This interconnected design allows for seamless integration and expansion, accommodating varying scales of cloud deployments.

Overall, this invention provides a transformative approach to virtual machine management by combining discrete time simulation with automation and predictive analytics. Its key features—data fusion, temporal analysis, automated snapshot generation, and comprehensive utilities—address the complexities of distributed cloud environments, offering a robust, efficient, and secure solution that stands out for its integration of advanced simulation techniques and practical management tools.

Various example embodiments in the disclosure are designed to fulfill the objectives previously mentioned, drawing on the illustrations provided within this disclosure. These illustrations showcase a variety of systems and methods for putting the disclosed concepts into practice. It is understood that different approaches to implementation are feasible, and adjustments to both the structure and operation of these systems and methods are permissible. Thus, the description elaborates on numerous connections among components, which should be understood in a flexible sense. Unless specifically noted otherwise, such connections may be direct or indirect and can be facilitated through either wired or wireless means. This document is not intended to limit the form or type of these connections.

Several types of artificial intelligence (AI) are applicable to implementing aspects of this invention, each offering unique capabilities to enhance its functionality. Supervised Learning involves training a model on labeled data to make predictions or decisions, defined by its reliance on input-output pairs to learn patterns. This type is applicable to the Prediction Engine, where it can forecast resource needs based on historical system parameters like CPU and memory usage. Examples include Linear Regression for simple trend prediction or Random Forest models in scikit-learn for more complex resource estimation, trained on datasets of past VM performance.

Reinforcement Learning, characterized by an agent learning optimal actions through trial and error to maximize a reward, is suited for the Maintenance Utility. It can determine the best maintenance actions (e.g., resource reallocation) by learning from feedback on VM stability post-action. Implementations like Q-Learning or Deep Q-Networks using TensorFlow could optimize maintenance strategies, adapting to real-time health status changes.

Unsupervised Learning, which identifies patterns in unlabeled data without predefined outputs, applies to the Grid Diagnostic Module. It can cluster VMs based on usage patterns to detect underutilized grids without prior examples. K-Means Clustering in Python's scikit-learn or Autoencoders in PyTorch could analyze usage data, grouping VMs with low CPU and memory metrics for diagnosis.

Time-Series Analysis, a specialized AI technique for modeling temporal data, is ideal for the System Parameter Analyzer. It examines the evolution of parameters over time, predicting trends like GPU usage spikes. ARIMA models in statsmodels or LSTM networks in Keras could process fused data, offering precise temporal insights for simulation and forecasting.

Each AI type enhances specific components, integrating data-driven intelligence into the DTS Framework, making the invention adaptable and efficient in managing virtual machines dynamically across a distributed cloud environment.

The system architecture diagram, FIG. 1, represents a comprehensive structure for managing virtual machines in a distributed cloud environment through discrete time simulation, encompassing multiple interconnected components. At the highest level, the Distributed Cloud Environment (100) serves as the overarching infrastructure, hosting all other elements and providing the computational resources necessary for operation. This could be implemented using platforms like Amazon Web Services, Microsoft Azure, or Google Cloud Platform, which offer scalable cloud services across multiple regions. Within this environment resides the Virtual Machine (VM) (102), a core entity that executes applications and processes data. Examples include virtualized instances like an Ubuntu server on AWS EC2 or a Windows VM on Azure, configured to run specific workloads.

Central to the architecture is the Discrete Time Simulation (DTS) Framework (104), which orchestrates the entire system. This framework could be implemented as a custom software suite running on a dedicated server, using tools like Python with simulation libraries such as SimPy. It connects to the Virtual Machine Registry (106), a database storing metadata and configurations for all virtual machines. A relational database like PostgreSQL or a NoSQL solution like MongoDB could serve this purpose, tracking details such as VM IDs and resource allocations. Similarly, the Snapshot Repository (108) stores snapshots of virtual machine states, potentially using a file storage system like Amazon S3 or a local NAS device, ensuring quick access to configuration backups.

The Telemetric Devices (110) monitor hardware parameters of the Virtual Machine (102). These could be physical sensors or software agents like Prometheus exporters installed on the VM, collecting metrics such as CPU usage and memory consumption in real time. Data from these devices feeds into the Data Fusion Processor (112), a component within the DTS Framework (104) that consolidates diverse data sources. This processor might be a data integration tool built with Apache Kafka or a custom script aggregating logs and telemetry, producing a unified dataset for analysis.

The System Parameter Analyzer (114), another module within the DTS Framework (104), processes this fused data to evaluate system performance over time. It could be implemented using a time-series analysis tool like InfluxDB paired with analytical scripts in R or Python, focusing on parameters like GPU usage. This analysis informs the Prediction Engine (116), which forecasts future resource needs. A machine learning platform such as TensorFlow or a statistical model in SciPy could power this engine, predicting VM requirements based on historical trends.

The Snapshot Generator (118), also within the DTS Framework (104), creates automated snapshots for deployment. This could be a script leveraging configuration management tools like Ansible or a custom application generating code in YAML, tailored to specific deployment lanes. These snapshots are handled by the Deployment Module (120), which deploys them to the Centralized Repository (122) and the Target Cluster (124). The Deployment Module (120) might use a CI/CD pipeline tool like Jenkins, while the Centralized Repository (122) could be an object storage service like Google Cloud Storage, and the Target Cluster (124) might be a Kubernetes cluster hosting the deployed VMs.

Within the DTS Framework (104), the Prognosis Utility (126) forecasts operational states, potentially using a forecasting library like Prophet integrated into a Python application, providing long-term insights. The Health Monitoring Utility (128) tracks VM performance against thresholds, implementable with a monitoring system like Nagios or Zabbix, alerting on metrics exceeding limits. The Maintenance Utility (130) responds to these alerts by executing corrective actions, possibly through automated scripts or orchestration tools like Puppet, ensuring VM stability.

The Grid Diagnostic Module (132) identifies underutilized resources within the Virtual Machine (102), which could be a custom analytics tool analyzing usage data from the System Parameter Analyzer (114). Its findings feed into the Security Module (134), which enforces access restrictions, potentially using an identity management system like Keycloak to limit access to privileged entities. The Scheduler (136) coordinates periodic execution of these modules, implementable as a cron job or a task scheduler like Apache Airflow, ensuring continuous operation.

The Deployment Module (120) also connects to the External Cloud Orchestration Tool (138), enhancing deployment capabilities. This tool could be Kubernetes or Terraform, integrating the system with containerized environments for broader compatibility. Finally, the Centralized Repository (122) links to the Distributed Repository (140), which spans multiple regions for reduced latency. This could be a distributed storage solution like Ceph or AWS S3 with cross-region replication, storing snapshots and data for global access.

The connections in FIG. 1 illustrate a flow of data and control, starting from the Distributed Cloud Environment (100) encompassing the Virtual Machine (102) and the DTS Framework (104). The DTS Framework (104) interacts with its internal components and external repositories, while the Telemetric Devices (110) feed data into the processing pipeline. The Scheduler (136) ties the system together by triggering periodic actions across all utilities, ensuring a dynamic and responsive architecture for managing virtual machines effectively.

The flow diagram, FIG. 2, provides a detailed representation of the operational process for managing virtual machines in a distributed cloud environment through discrete time simulation, beginning with the initialization of the system. The process starts by initializing the Discrete Time Simulation (DTS) Framework with a virtual machine registry, snapshot repository, and telemetric devices (200). This step involves setting up the foundational components, such as creating a database for the registry using PostgreSQL to store virtual machine metadata, establishing an S3 bucket for the snapshot repository, and activating software agents like Prometheus exporters as telemetric devices. Next, the flow moves to configuring the telemetric devices to monitor hardware parameters of a virtual machine (202). This can be implemented by connecting these agents to the virtual machine via API calls and starting real-time metric collection, ensuring parameters like CPU and memory usage are tracked continuously.

Following configuration, the process collects telemetry data, event logs, and application heuristics from the virtual machine via the telemetric devices (204). This step might involve aggregating system logs from a logging service like ELK Stack, pulling heuristics from application performance monitoring tools like New Relic, and retrieving telemetry from the configured devices, creating a comprehensive dataset. The flow then proceeds to process data fusion by consolidating the collected telemetry data, event logs, and application heuristics into fused data using the Data Fusion Processor (206). Implementation could leverage Apache Kafka to stream and merge these diverse data sources into a unified format, stored temporarily in a data lake like Apache Hadoop for further processing.

The next step involves analyzing the temporal evolution of system parameters, including CPU usage, memory usage, and GPU usage, based on the fused data using the System Parameter Analyzer (208). This can be executed with a time-series database like InfluxDB, where scripts in Python with libraries such as Pandas calculate trends and averages over discrete time intervals, providing a detailed performance profile. Subsequently, the flow predicts future resource needs of the virtual machine over a time interval using the Prediction Engine based on the analyzed system parameters (210). This prediction might employ a machine learning model built with TensorFlow, trained on historical data to forecast resource demands, such as estimating the need for additional VMs in a week based on current usage patterns.

The process continues by generating a snapshot for the virtual machine by auto-coding instructions based on software requirements, project versions, and a deployment lane-specific configuration template using the Snapshot Generator (212). This step could use a tool like Ansible to script configuration files in YAML, incorporating details like Python 3.9 as the software requirement and a production lane template, producing a deployable snapshot. The flow then deploys the snapshot with metadata to a centralized repository using the Deployment Module (214). Implementation might involve uploading the snapshot to Google Cloud Storage via a REST API, attaching metadata such as creation timestamps and VM identifiers for traceability.

Next, the snapshot is deployed from the centralized repository to a target cluster in the distributed cloud environment using the Deployment Module (216). This can be achieved by executing the auto-coded instructions in a Kubernetes cluster, using kubectl commands to instantiate the VM configuration seamlessly. The flow integrates the Deployment Module with an external cloud orchestration tool to deploy the snapshot into a containerized environment (218). This integration could leverage Terraform to define infrastructure-as-code, deploying the snapshot into a Docker container within the Kubernetes ecosystem, enhancing scalability.

The process also includes storing the fused data and snapshots in a distributed repository across multiple geographic regions (220). This might involve configuring AWS S3 with cross-region replication, ensuring data and snapshots are available in regions like US-East-1 and EU-West-1 to minimize latency. Following this, the flow forecasts a future operational state of the virtual machine based on the fused data using the Prognosis Utility (222). This utility could use the Prophet library in Python to generate a 30-day forecast, analyzing trends in the fused data to predict potential VM states and risks.

The next step monitors the health status of the virtual machine by comparing system parameters to predefined thresholds using the Health Monitoring Utility (224). Implementation might involve Zabbix, configured to check CPU usage against an 80% threshold, memory usage against 90%, and GPU usage against 85%, generating alerts if exceeded. The flow then checks if the health status exceeds these predefined thresholds (e.g., CPU usage>80%, memory usage>90%, GPU usage>85%) (226). This decision point could be coded as a conditional statement in a monitoring script, evaluating real-time data against these limits to determine the next action.

If thresholds are exceeded, the process executes maintenance actions on the virtual machine using the Maintenance Utility (228). This might involve running a Bash script to restart services or reallocate resources, triggered automatically via an alert from Zabbix. If thresholds are not exceeded, the flow proceeds to diagnose unused grids (230), acting as a transition to the next step without additional implementation, ensuring a smooth continuation. The process then diagnoses unused grids in the virtual machine by identifying low CPU and memory usage (e.g., CPU<10%, memory<10%) using the Grid Diagnostic Module (232). This could be implemented with a custom Python script querying the System Parameter Analyzer's data, flagging VMs with minimal activity for review.

Subsequently, the flow restricts access to the diagnosed unused grids to privileged entities using the Security Module (234). This step might use Keycloak to update access policies, applying role-based access control to limit interaction to authorized users only, enhancing security. The process schedules the next iteration of the flow using the Scheduler to periodically repeat from data collection onward (236). This could be a cron job set to run hourly, managed by Apache Airflow, ensuring continuous operation. Finally, the flow ends the current iteration and loops back to collecting telemetry data, event logs, and application heuristics if scheduled (238). This loop can be implemented as a conditional return in the Airflow DAG, restarting the process based on the schedule, maintaining dynamic management.

The FIG. 2 flow diagram encapsulates a cyclical process where each step builds on the previous, leveraging specific tools and technologies for implementation. The sequence from initialization to data collection, analysis, prediction, snapshot generation, deployment, and ongoing monitoring and maintenance forms a robust workflow. The integration with external tools and distributed storage enhances flexibility, while the decision points and scheduling ensure responsiveness and efficiency in managing virtual machines within the distributed cloud environment.

The sequence diagram, FIGS. 3A-3D, provides an intricate portrayal of the interactions among actors in the process of managing virtual machines within a distributed cloud environment through discrete time simulation, starting with the initiation of the management cycle. The Virtual Machine sends a request to the DTS Framework to initialize the management process (300). This interaction can be implemented as an API call from the virtual machine, perhaps hosted on AWS EC2, to a central management service running on a Python-based server, triggering the DTS Framework to begin its operations. Following this, the DTS Framework sends a configuration command to the Telemetric Devices to start monitoring hardware parameters (302). This step might involve the framework issuing RESTful commands to software agents like Prometheus exporters installed on the virtual machine, instructing them to activate and begin collecting metrics such as CPU and memory usage.

In response, the Telemetric Devices return telemetry data, event logs, and application heuristics to the DTS Framework (304). This could be executed by the agents pushing JSON-formatted data back to the framework via a webhook, including detailed logs from a syslog server and heuristics from an APM tool like Dynatrace. The DTS Framework then forwards the collected data to the Data Fusion Processor for consolidation (306). This transfer might use a message queue like RabbitMQ, ensuring reliable delivery of the raw data to a processing module written in Python with Pandas for data merging. The Data Fusion Processor processes and returns fused data to the DTS Framework (308). Here, the processor could aggregate the data into a single dataset using Apache Spark, sending it back as a structured CSV file over an internal API.

Next, the DTS Framework sends the fused data to the System Parameter Analyzer for temporal analysis (310). This interaction might involve passing the dataset to a time-series analysis service built with InfluxDB and Python scripts, hosted within the framework's ecosystem. The System Parameter Analyzer returns analyzed system parameters to the DTS Framework (312). This return could be implemented as a JSON response containing calculated averages and trends for CPU, memory, and GPU usage, delivered via a REST endpoint. The DTS Framework then sends these system parameters to the Prediction Engine to forecast resource needs (314). This step might use gRPC to transmit the data to a TensorFlow-based prediction service running on a separate node, optimized for machine learning tasks.

The Prediction Engine returns predicted resource needs to the DTS Framework (316). This could be a structured response with forecasted VM counts and resource estimates, sent back over gRPC for efficiency. Following this, the DTS Framework sends a request to the Snapshot Generator to create a snapshot based on software requirements and a configuration template (318). This interaction might involve an HTTP POST request with JSON payload specifying Python 3.9 and a production lane template, targeting a generator built with Ansible. The Snapshot Generator returns the generated snapshot with auto-coded instructions to the DTS Framework (320). The return could be a YAML file containing the snapshot, delivered via an HTTP response, ready for deployment.

The DTS Framework then sends the snapshot and metadata to the Deployment Module for deployment (322). This step might use an internal message bus like ZeroMQ to pass the snapshot to a deployment service integrated with Jenkins. The Deployment Module sends the snapshot to the Centralized Repository for storage (324). This could be implemented by uploading the YAML file to Amazon S3 using the AWS SDK, with metadata like timestamp and VM ID attached. The Centralized Repository confirms storage completion to the Deployment Module (326). This confirmation might be a simple HTTP 200 OK response from S3, signaling successful upload.

Subsequently, the Deployment Module sends the snapshot to the Target Cluster for execution (328). This step could involve executing kubectl commands to deploy the snapshot into a Kubernetes cluster, applying the auto-coded instructions directly. The Target Cluster confirms deployment success to the Deployment Module (330). This confirmation might be a Kubernetes event notification relayed back via an API callback, indicating the VM is running. The Deployment Module notifies the DTS Framework of successful deployment (332). This notification could be a message sent over ZeroMQ, updating the framework on the deployment status.

The DTS Framework then sends the fused data to the Prognosis Utility for operational state forecasting (334). This might involve an API call passing the CSV dataset to a forecasting service using the Prophet library in Python. The Prognosis Utility returns a forecast to the DTS Framework (336). This return could be a JSON object with a 30-day forecast and risk assessment, delivered via the API response. Next, the DTS Framework sends the system parameters to the Health Monitoring Utility to check health status (338). This step might use REST to send the parameters to a monitoring service like Nagios, configured with threshold rules.

The Health Monitoring Utility returns the health status to the DTS Framework (340). This could be a JSON response detailing CPU, memory, and GPU usage against thresholds, sent back over REST. If the health status exceeds thresholds, the DTS Framework sends a maintenance request to the Maintenance Utility (342). This conditional interaction might trigger a script via an HTTP POST to a Puppet-based service, requesting resource adjustments. The Maintenance Utility executes actions and returns confirmation to the DTS Framework (344). This confirmation could be a success message over HTTP, indicating completed maintenance tasks like service restarts.

Regardless of maintenance, the DTS Framework sends the system parameters to the Grid Diagnostic Module to identify unused grids (346). This might involve a REST call to a diagnostic service written in Python, analyzing usage data. The Grid Diagnostic Module returns identified unused grids to the DTS Framework (348). This return could be a list of VM segments with low usage in JSON format, sent via REST. The DTS Framework then sends a restriction request to the Security Module for the unused grids (350). This step might use an API call to Keycloak, requesting access policy updates.

The Security Module confirms access restriction to the DTS Framework (352). This confirmation could be an HTTP 200 response from Keycloak, verifying restricted access. The DTS Framework sends a scheduling request to the Scheduler to repeat the process (354). This might involve an RPC call to Apache Airflow, setting the next iteration time. The Scheduler confirms the next iteration schedule to the DTS Framework (356). This confirmation could be a response with the scheduled time, sent back over RPC. Finally, the DTS Framework sends a new monitoring request to the Telemetric Devices to restart the sequence (358). This step could be another RESTful command to the Prometheus agents, looping the process for continuous management.

The sequence diagram, FIGS. 3A-3C, meticulously maps out the communication flow, showing how each actor interacts through specific, implementable mechanisms like APIs, message queues, and direct commands. The use of modern tools such as AWS SDK, Kubernetes, and machine learning libraries ensures practical execution, while the cyclical nature of the sequence, driven by the Scheduler, supports ongoing dynamic management of virtual machines in the distributed cloud environment.

The class diagram, FIGS. 4A-4B, offers a comprehensive depiction of the software architecture for managing virtual machines in a distributed cloud environment through discrete time simulation, presenting a detailed set of classes, their attributes, methods, and relationships. The Virtual Machine (400) class represents the core entity being managed, encapsulating attributes such as vmID, softwareVersion, projectVersion, cpuUsage, memoryUsage, gpuUsage, eventLogs, applicationHeuristics, and systemParameters. These attributes allow tracking of unique identifiers, software configurations, resource usage metrics, and operational data, which could be implemented using a Java class with fields like Integer for vmID and ArrayList for eventLogs. Methods like updateUsage, logEvent, and addHeuristic enable dynamic updates to resource metrics and logging, potentially coded with setter methods and list append operations in a programming environment like Eclipse.

The DTS Framework (402) class serves as the central orchestrator, containing attributes vmRegistry, snapshotRepository, and telemetricDevices, structured as dictionaries and lists to manage collections of virtual machines, snapshots, and monitoring devices. This class could be realized in Python using dict for vmRegistry and list for telemetricDevices, leveraging its flexibility for dynamic data management. Its methods, including initializeDTSFramework, configureHardwareTelemetry, startDataFusionProcessor, startSystemParameterAnalyzer, startPredictionEngine, and main, initiate and coordinate the system's operations, implementable as a main script with function calls to instantiate and start related components, possibly hosted on a server running Flask for API integration.

The Telemetric Device (404) class models the hardware monitoring agents with attributes deviceID, isConnected, and monitoredVM, tracking device identity, connection status, and the VM it monitors. This could be a C++ class interfacing with hardware sensors, using boolean for isConnected and int for deviceID. Methods connect, startMonitoring, and getTelemetry manage device activation and data retrieval, executable as member functions calling system-level APIs to interface with physical or virtual telemetry hardware, such as those provided by Prometheus.

The Data Fusion Processor (406) class, with its fusedData attribute, consolidates diverse data sources into a unified dataset, potentially implemented in Scala with Apache Spark for big data processing, using a Map for fusedData. Its processDataFusion method merges inputs from telemetry and logs, callable as a Spark job processing streams from Kafka. The System Parameter Analyzer (408) class, featuring a parameters attribute, analyzes temporal trends with methods like analyzeTemporalEvolution, calculateAverage, extractTrends, and extractPatterns. This could be a Python class using Pandas and NumPy, with a dict for parameters, running statistical computations on a Jupyter notebook environment.

The Prediction Engine (410) class, with attributes predictedParams and vmCount, forecasts resource needs using methods predictFutureNeeds, extrapolate, and estimateVMCount. Implementable in Python with TensorFlow, it might use a dict for predictedParams and integer for vmCount, training models on historical data within a cloud-hosted ML pipeline. The Snapshot Generator (412) class, with a snapshotID attribute, generates deployment snapshots through methods like generateSnapshot, analyzeSoftwareRequirements, loadConfigTemplate, generateCode, createMetadata, assignTargetCluster, and generateUniqueID. This could be a Ruby class integrated with Ansible, managing snapshot creation with a unique integer ID, producing YAML configurations for deployment.

The Snapshot (414) class defines the snapshot structure with attributes snapshotID, autoGeneratedCode, metadata, and targetCluster, serving as a data holder without methods, possibly a simple struct in C stored in a database like MongoDB. The Deployment Module (416) class, lacking attributes, manages deployment with methods deploySnapshot, uploadToCentralizedRepo, and deployToTargetCluster, implementable as a Go service using REST APIs to interact with storage and clusters, such as pushing files to S3 and executing kubectl commands.

The Centralized Repository (418) class, with a snapshots attribute, stores snapshots, potentially a Java class interfacing with AWS S3 via its SDK, using a HashMap for snapshots. Its upload method facilitates storage, callable as an S3 putObject operation. The Target Cluster (420) class, with attributes clusterID and deployedSnapshots, represents the deployment destination, implementable in Kotlin with Kubernetes APIs, using String for clusterID and List for deployedSnapshots. Its deploy method executes configurations, possibly via Kubernetes client libraries.

The Prognosis Utility (422) class, with a prognosisReport attribute, forecasts operational states using runPrognosis and assessRisks methods, potentially a Python class with Prophet for time-series forecasting, storing results in a dict. The Health Monitoring Utility (424) class, with a healthStatus attribute, monitors VM health with methods monitorHealth, checkThreshold, and anyThresholdExceeded, implementable in Node.js with a Map for healthStatus, integrating with monitoring tools like Zabbix for real-time checks.

The Maintenance Utility (426) class, featuring a maintenanceActions attribute, handles upkeep with methods triggerMaintenance, identifyActions, executeAction, and updateVMStatus, possibly a Bash script wrapper in a Python class with a list for actions, automating tasks via Puppet. The Grid Diagnostic Module (428) class, with an unusedGrids attribute, identifies underutilization using diagnoseUnusedGrids, implementable in PHP with a list for unusedGrids, querying usage data via SQL. The Security Module (430) class, with accessPolicies, restricts access using restrictAccess and updateAccessPolicy, potentially a Java Spring service with a HashMap, integrating with Keycloak for policy enforcement.

The Scheduler (432) class, with a scheduleInterval attribute, manages timing with scheduleNextRun, implementable in Python with APScheduler, using an integer for interval, scheduling tasks across the framework. Interconnections show the DTS Framework (402) as a composite hub, containing instances of processor, analyzer, engine, generator, module, and utility classes, linked to external repositories and clusters. The Virtual Machine (400) interacts with Telemetric Device (404), feeding data through the Data Fusion Processor (406) to the System Parameter Analyzer (408), cascading to Prediction Engine (410) and Snapshot Generator (412), which produces Snapshot (414) instances deployed via Deployment Module (416) to Centralized Repository (418) and Target Cluster (420). The Scheduler (432) orchestrates periodic execution, ensuring continuous operation across all components.

This FIG. 4 class diagram provides a robust framework for software implementation, detailing how each class encapsulates specific responsibilities and interacts through defined relationships, enabling a scalable and maintainable system for virtual machine management in a distributed cloud environment.

Pseudocode exemplars for implementing various aspects of this disclosure are set forth below with explanations for reference.

### Define Global Structures and Variables

Structure VirtualMachine
   Integer vmID
   String softwareVersion
   String projectVersion
   Float cpuUsage
   Float memoryUsage
   Float gpuUsage
   List eventLogs
   List applicationHeuristics
   Dictionary systemParameters
End Structure
Structure Snapshot
   Integer snapshotID
   String autoGeneratedCode
   Dictionary metadata
   String targetCluster
End Structure
Dictionary vmRegistry//Key: vmID, Value: VirtualMachine
Dictionary snapshotRepository//Key: snapshotID, Value: Snapshot
List telemetricDevices

### Initialize the Discrete Time Simulation (DTS) Framework

Function InitializeDTSFramework( )
   vmRegistry=New Dictionary
   snapshotRepository=New Dictionary
   telemetricDevices=New List
   ConfigureHardwareTelemetry( )
   StartDataFusionProcessor( )
   StartSystemParameterAnalyzer( )
   StartPredictionEngine( )
End Function

### Configure hardware telemetry devices

Function ConfigureHardwareTelemetry( )
   For Each device in availableDevices
      telemetricDevices. Add(device)
      device.Connect( )
      device.StartMonitoring( )
   End For
End Function

### Data Fusion and Processing Block

Function ProcessDataFusion(vmID)
   vm=vmRegistry[vmID]
   fusedData=New Dictionary
   For Each log in vm.eventLogs
      fusedData[“logs”]. Append(log)
   End For
   For Each heuristic in vm.applicationHeuristics
      fusedData[“heuristics”].Append(heuristic)
   End For
   For Each device in telemetricDevices
      telemetry=device. GetTelemetry(vmID)
      fusedData[“telemetry”].Append(telemetry)
   End For
   vm.systemParameters=AnalyzeTemporalEvolution(fusedData)
   Return fusedData
End Function

### Temporal Evolution of System Parameters

Function AnalyzeTemporalEvolution(fusedData)
   parameters=New Dictionary
   parameters[“cpu”]=CalculateAverage(fusedData[“telemetry”][“cpu”])
   parameters[“memory”]=CalculateAverage(fusedData[“telemetry”][“memory”])
   parameters[“gpu”]=CalculateAverage(fusedData[“telemetry”][“gpu”])
   parameters[“logTrends”]=ExtractTrends(fusedData[“logs”])
   parameters[“heuristicPatterns”]=ExtractPatterns(fusedData[“heuristics”])
   Return parameters
End Function

### Prediction Engine for Resource Needs

Function PredictFutureNeeds(vmID, timeInterval)
   vm=vmRegistry[vmID]
   fusedData=ProcessDataFusion(vmID)
   currentParams=vm.systemParameters
   predictedParams=New Dictionary
   For Each param in currentParams
      predictedParams[param.Key]=Extrapolate(param.Value, timeInterval)
   End For
   vmCount=EstimateVMCount(predictedParams)
   Return predictedParams, vmCount
End Function

### Auto-Coding for Snapshot Creation

Function GenerateSnapshot(vmID, deploymentLane)
   vm=vmRegistry[vmID]
      softwareReqs=AnalyzeSoftwareRequirements(vm.softwareVersion, vm.projectVersion)
   configTemplate=LoadConfigTemplate(deploymentLane)
   autoCode=GenerateCode(softwareReqs, configTemplate)
   snapshot=New Snapshot
   snapshot.snapshotID=GenerateUniqueID( )
   snapshot.autoGeneratedCode=autoCode
   snapshot.metadata=CreateMetadata(vm)
   snapshot.targetCluster=AssignTargetCluster(deploymentLane)
   snapshotRepository[snapshot.snapshotID]=snapshot
   Return snapshot
End Function

### Deploy Snapshot to Centralized Repository

Function DeploySnapshot(snapshotID)
   snapshot=snapshotRepository[snapshotID]
   centralizedRepo. Upload(snapshot)
   targetCluster=snapshot.targetCluster
   targetCluster. Deploy(snapshot.autoGeneratedCode, snapshot.metadata)
End Function

### Prognosis Utility

Function RunPrognosis(vmID)
   vm=vmRegistry[vmID]
   fusedData=ProcessDataFusion(vmID)
   prognosisReport=New Dictionary
   prognosisReport[“futureState”]=PredictFutureNeeds(vmID, 30)//30-day forecast
   prognosisReport[“risks”]=AssessRisks(vm.systemParameters)
   Return prognosisReport
End Function

### Health Monitoring Utility

Function MonitorHealth(vmID)
   vm=vmRegistry[vmID]
   fusedData=ProcessDataFusion(vmID)
   healthStatus=New Dictionary
   healthStatus[“cpu”]=CheckThreshold(vm.systemParameters[“cpu”], 80.0)
      healthStatus[“memory”]=CheckThreshold(vm.systemParameters[“memory”], 90.0)
   healthStatus[“gpu”]=CheckThreshold(vm.systemParameters[“gpu”], 85.0)
   If AnyThresholdExceeded(healthStatus)
      TriggerMaintenance(vmID)
   End If
   Return healthStatus
End Function

### Maintenance Utility

Function TriggerMaintenance(vmID)
   vm=vmRegistry[vmID]
   maintenanceActions=IdentifyActions(vm.systemParameters)
   For Each action in maintenanceActions
      ExecuteAction(action, vm)
   End For
   UpdateVMStatus(vmID)
End Function

### Diagnose Unused Grids

Function DiagnoseUnusedGrids( )
   unusedGrids=New List
   For Each vm in vmRegistry
      If vm.cpuUsage <10 AND vm.memoryUsage <10
         unusedGrids. Add(vm.vmID)
      End If
   End For
   RestrictAccess(unusedGrids)
   Return unusedGrids
End Function

### Security Services

Function RestrictAccess(unusedGrids)
   For Each vmID in unusedGrids
      vm=vmRegistry[vmID]
      vm.UpdateAccessPolicy(“privilegedOnly”)
   End For
End Function

### Main Execution Loop

Function Main( )
   InitializeDTSFramework( )
   While SystemRunning
      For Each vmID in vmRegistry
         ProcessDataFusion(vmID)
         PredictFutureNeeds(vmID, 7)//Weekly prediction
         snapshot=GenerateSnapshot(vmID, CurrentLane( ))
         DeploySnapshot(snapshot.snapshotID)
         RunPrognosis(vmID)
         MonitorHealth(vmID)
         DiagnoseUnusedGrids( )
      End For
      Sleep(3600)//Run hourly
   End While
End Function

The pseudocode provided outlines a sample implementation of a system for managing virtual machines in a distributed cloud environment using discrete time simulation. It begins by defining two primary data structures: VirtualMachine and Snapshot. The VirtualMachine structure captures essential attributes such as a unique identifier, software and project versions, resource usage metrics like CPU, memory, and GPU, and collections of event logs, application heuristics, and system parameters. The Snapshot structure includes an identifier, automatically generated code, metadata, and a target cluster designation, representing the configuration state of a virtual machine ready for deployment. Global variables include dictionaries to store virtual machines and snapshots, as well as a list for telemetric devices, establishing the foundational data management framework.

The InitializeDTSFramework function sets up the system by creating empty dictionaries for virtual machines and snapshots and initializing a list of telemetric devices. It triggers the configuration of hardware telemetry, starts the data fusion processor, activates the system parameter analyzer, and launches the prediction engine. This initialization ensures that all components of the discrete time simulation framework are operational, providing a coordinated starting point for managing virtual machines across the distributed environment.

The ConfigureHardwareTelemetry function connects and activates monitoring for each available telemetric device. It iterates through a set of devices, adds them to the telemetric devices list, establishes a connection, and begins data collection. This step ensures that real-time hardware data, such as CPU and memory usage, is available for analysis, forming the basis for accurate simulation and resource assessment within the system.

The ProcessDataFusion function handles the data fusion and processing block by taking a virtual machine identifier as input and retrieving the corresponding virtual machine from the registry. It consolidates event logs, application heuristics, and telemetry data from connected devices into a single dictionary. This fused data is then passed to the AnalyzeTemporalEvolution function to update the virtual machine's system parameters, enabling a unified view of operational metrics that supports subsequent simulation and prediction tasks.

The AnalyzeTemporalEvolution function processes the fused data to determine the temporal evolution of system parameters. It calculates averages for CPU, memory, and GPU usage from telemetry data and extracts trends from event logs and patterns from application heuristics. These computed parameters are stored in a dictionary and returned, providing a detailed snapshot of how the virtual machine's performance evolves over time, which is essential for predictive modeling.

The PredictFutureNeeds function implements the prediction engine by taking a virtual machine identifier and a time interval as inputs. It retrieves the virtual machine, processes its fused data, and extrapolates current system parameters over the specified interval. It estimates the number of virtual machines needed based on these predictions and returns both the predicted parameters and the count. This predictive capability allows the system to anticipate future resource requirements, supporting proactive infrastructure planning.

The GenerateSnapshot function automates snapshot creation for a given virtual machine and deployment lane. It analyzes the software and project version requirements, loads an environment-specific configuration template, and generates code based on these inputs. A new snapshot is created with a unique identifier, the auto-generated code, metadata derived from the virtual machine, and a target cluster assignment. The snapshot is stored in the repository and returned, streamlining the preparation of virtual machines for deployment.

The DeploySnapshot function handles the deployment process by retrieving a snapshot from the repository using its identifier. It uploads the snapshot to a centralized repository and deploys the auto-generated code and metadata to the designated target cluster. This one-click deployment mechanism ensures that virtual machines are efficiently integrated into the distributed cloud environment, maintaining consistency across deployment lanes.

The RunPrognosis function provides a prognosis utility by processing fused data for a virtual machine and generating a 30-day forecast of its future state using the prediction engine. It assesses risks based on current system parameters and returns a report combining these insights. This utility enables forward-looking analysis, helping administrators anticipate potential issues and plan accordingly.

The MonitorHealth function implements the health monitoring utility by processing fused data and checking system parameters against predefined thresholds, such as 80% for CPU, 90% for memory, and 85% for GPU usage. If any threshold is exceeded, it triggers maintenance actions. The function returns a health status dictionary, offering continuous oversight of virtual machine performance and triggering interventions when necessary.

The TriggerMaintenance function executes maintenance actions for a virtual machine identified as needing attention. It identifies required actions based on system parameters, executes each action, and updates the virtual machine's status. This utility ensures that virtual machines remain operational and optimized, addressing issues identified during health monitoring.

The DiagnoseUnusedGrids function identifies underutilized virtual machines by checking for CPU and memory usage below 10%. It compiles a list of such machines and restricts access to them, returning the list. This feature enhances resource efficiency by pinpointing unused capacity within the infrastructure, allowing for reallocation or security adjustments.

The RestrictAccess function enforces security by updating the access policy of underutilized virtual machines to allow only privileged entities. It iterates through the list of unused grids, ensuring that these segments of the infrastructure are protected against unauthorized use, thereby enhancing the overall security of the distributed cloud environment.

The Main function serves as the execution loop, initializing the framework and running continuously while the system is active. It iterates through all registered virtual machines hourly, processing data fusion, predicting weekly needs, generating and deploying snapshots, running prognosis, monitoring health, and diagnosing unused grids. This loop ensures that the system operates dynamically, adapting to changes in the distributed cloud environment in real time.

The pseudocode encapsulates various sample aspects of the invention, including the use of discrete time simulation for modeling virtual machine behavior, automation of snapshot creation and deployment, and utilities for prognosis, health monitoring, maintenance, and security. It integrates data fusion, temporal analysis, and predictive modeling into a cohesive framework, providing a robust solution for managing virtual machines in a distributed cloud setting.

The systems and methods described in the disclosure for managing virtual machines in a distributed cloud environment using discrete time simulation offer a versatile foundation that accommodates numerous alternatives, modifications, combinations, and customizations within the spirit and scope of the technology. One potential alternative involves adjusting the granularity of the discrete time intervals used in the simulation framework. While the pseudocode suggests hourly execution loops and weekly predictions, the system could be modified to operate on shorter intervals, such as every minute, or longer intervals, such as daily or monthly, depending on the specific needs of the deployment environment. This customization allows the system to adapt to varying workloads, ensuring timely responses to rapid changes or providing broader trend analysis for stable operations.

Another modification could involve expanding the types of system parameters analyzed beyond CPU, memory, and GPU usage. The framework might incorporate additional metrics, such as network bandwidth, storage input/output rates, or power consumption, to provide a more comprehensive view of virtual machine performance. This enhancement would enable the system to address a wider range of resource constraints, tailoring predictions and maintenance actions to the unique characteristics of the distributed cloud infrastructure in use.

The data fusion and processing block presents opportunities for customization by integrating alternative data sources. Instead of relying solely on event logs, application heuristics, and telemetry data, the system could include inputs from external monitoring tools, user activity logs, or third-party performance analytics platforms. This combination would enrich the dataset, potentially improving the accuracy of temporal evolution analysis and predictions, and allowing the system to adapt to diverse operational contexts where additional data is available.

A further alternative could involve varying the machine learning models employed within the prediction engine. The current description implies a generic data-driven approach, but this could be customized to use specific algorithms, such as time-series forecasting with ARIMA, neural networks for pattern recognition, or regression models for resource estimation. Each model could be selected based on the nature of the workload or the computational resources available, offering flexibility in balancing prediction accuracy with processing overhead.

The auto-coding mechanism for snapshot creation could be modified to support different programming languages or configuration formats. While the pseudocode does not specify a language, the system could generate code in Python, Java, or YAML, depending on the preferences of the deployment environment. Additionally, the configuration templates could be customized to include lane-specific policies, such as security protocols for production versus relaxed settings for development, enhancing compatibility with existing workflows.

The deployment process itself could be altered to support multiple centralized repositories rather than a single one. This modification would allow snapshots to be stored in geographically distributed locations, reducing latency for deployments across global cloud regions. Alternatively, the system could integrate with existing cloud orchestration tools, such as Kubernetes or Terraform, to deploy snapshots directly into containerized environments, broadening the applicability of the technology to hybrid setups.

The prognosis utility could be customized to provide forecasts over different time horizons. While a 30-day forecast is suggested, the system might offer short-term predictions (e.g., 24 hours) for immediate planning or long-term projections (e.g., six months) for strategic resource allocation. This flexibility ensures that the utility aligns with the planning cycles of the organization using the system.

Health monitoring thresholds could be adjusted to reflect the tolerances of specific virtual machines or applications. Instead of fixed values like 80% for CPU or 90% for memory, the system could dynamically set thresholds based on historical performance data or user-defined preferences. This customization would prevent unnecessary maintenance triggers in high-capacity systems or ensure rapid intervention in sensitive ones.

The maintenance utility could be enhanced by incorporating automated scaling actions. Beyond executing predefined maintenance tasks, the system might automatically provision additional virtual machines or deallocate underused ones in response to health monitoring results. This combination of maintenance and scaling would create a self-regulating infrastructure, reducing administrative oversight.

Security services could be modified to include advanced access control mechanisms. Rather than restricting unused grids to privileged entities, the system might implement role-based access control, multi-factor authentication, or encryption of snapshot data in transit and at rest. These alternatives would strengthen the security posture, aligning with stricter compliance requirements in certain industries.

The diagnosis of unused grids could be expanded to consider additional criteria, such as time of day or application priority. For instance, the system might identify grids as unused only during off-peak hours or prioritize retaining capacity for high-priority tasks. This customization would optimize resource use in environments with variable demand patterns.

The architecture could be adapted to support a modular design, where components like data fusion, prediction, and deployment operate as independent services. This modification would allow organizations to deploy only the needed modules, integrating them with existing systems or scaling them separately based on computational resources. Such a combination enhances deployment flexibility.

Integration with edge computing environments represents another potential customization. The system could extend discrete time simulation to virtual machines running on edge devices, incorporating latency-sensitive parameters like network jitter or device proximity. This adaptation would broaden the scope to include Internet of Things deployments within the distributed cloud framework.

The pseudocode's main execution loop could be altered to run in an event-driven manner rather than on a fixed schedule. Instead of hourly iterations, the system might trigger processes in response to specific events, such as a spike in resource usage or the onboarding of a new virtual machine. This alternative would improve responsiveness in dynamic environments.

Combinations of these modifications could be implemented to create tailored solutions. For example, integrating dynamic health thresholds with automated scaling and edge computing support would produce a system optimized for real-time, distributed workloads. Alternatively, combining multi-repository deployment with advanced security features and modular architecture could cater to large-scale, security-conscious organizations.

The framework could also support simulation of hybrid cloud setups, where virtual machines span public and private clouds. By customizing the prediction engine to account for cost metrics or data sovereignty requirements, the system would adapt to mixed infrastructures, ensuring efficient resource allocation across boundaries.

Another modification might involve adding a user interface layer to the system. Administrators could interact with the discrete time simulation framework through a dashboard displaying prognosis reports, health statuses, and snapshot deployment progress. This customization would enhance usability without altering the core functionality.

The system could be adapted for specific industries by customizing the parameters and utilities. For instance, in a machine learning context, the prediction engine might prioritize GPU usage, while in a web hosting environment, it might focus on network bandwidth. This flexibility ensures relevance across diverse use cases.

While the present technology has been explained through what are currently regarded as the most practical and preferred embodiments, it should be recognized that these specifics are provided solely for illustrative purposes, and the disclosure is not confined to the particular descriptions and embodiments outlined. Instead, it is intended to encompass modifications and comparable arrangements that fall within the spirit and scope of the appended claims. For instance, it is understood that the present technology envisions the possibility of integrating, where feasible, one or more elements from any given embodiment with one or more elements from any other embodiment. This approach ensures that the system remains adaptable, allowing for the incorporation of new techniques, data sources, or operational requirements as they emerge, all while maintaining the core principles of discrete time simulation and automated virtual machine management in a distributed cloud environment.

1. A method for managing virtual machines in a distributed cloud environment using discrete time simulation, the method comprising:
initializing, by a discrete time simulation (DTS) framework, a system including a virtual machine registry, a snapshot repository, and telemetric devices;
configuring, by the DTS framework, the telemetric devices to monitor hardware parameters of a virtual machine;
processing, by a data fusion processor of the DTS framework, data fusion for the virtual machine by consolidating event logs, application heuristics, and telemetry data into fused data;
analyzing, by a system parameter analyzer of the DTS framework, temporal evolution of system parameters including CPU usage, memory usage, and GPU usage based on the fused data;
predicting, by a prediction engine of the DTS framework, future resource needs of the virtual machine over a time interval using the system parameters;
generating, by a snapshot generator of the DTS framework, a snapshot for the virtual machine by auto-coding instructions based on software requirements, project versions, and a configuration template specific to a deployment lane;
deploying, by a deployment module of the DTS framework, the snapshot with metadata to a centralized repository and a target cluster in the distributed cloud environment;
forecasting, by a prognosis utility of the DTS framework, a future operational state of the virtual machine based on the fused data;
monitoring, by a health monitoring utility of the DTS framework, a health status of the virtual machine by comparing the system parameters to predefined thresholds;
maintaining, by a maintenance utility of the DTS framework, the virtual machine by executing actions when the health status exceeds the predefined thresholds;
diagnosing, by a grid diagnostic module of the DTS framework, unused grids in the virtual machine by identifying low CPU and memory usage;
restricting, by a security module of the DTS framework, access to the unused grids to privileged entities; and
repeating, by the DTS framework, the processing, predicting, generating, deploying, forecasting, monitoring, maintaining, diagnosing, and restricting steps periodically to manage the virtual machine dynamically.

2. The method of claim 1, wherein configuring, by the DTS framework, the telemetric devices includes connecting each telemetric device to the virtual machine and starting real-time monitoring of the hardware parameters.

3. The method of claim 2, wherein processing, by the data fusion processor, data fusion includes aggregating the event logs from multiple sources and extracting trends from the application heuristics.

4. The method of claim 3, wherein predicting, by the prediction engine, future resource needs includes extrapolating the system parameters to estimate a number of additional virtual machines required for the distributed cloud environment.

5. The method of claim 4, wherein generating, by the snapshot generator, the snapshot includes producing the auto-coding instructions in a programming language compatible with the target cluster.

6. The method of claim 5, wherein deploying, by the deployment module, the snapshot includes uploading the snapshot to the centralized repository and executing the auto-coding instructions in the target cluster with a single command.

7. The method of claim 6, wherein forecasting, by the prognosis utility, the future operational state includes generating a 30-day forecast and assessing risks based on current system parameters.

8. The method of claim 7, wherein monitoring, by the health monitoring utility, the health status includes checking the CPU usage against an 80% threshold, the memory usage against a 90% threshold, and the GPU usage against an 85% threshold.

9. The method of claim 8, wherein diagnosing, by the grid diagnostic module, unused grids includes identifying the virtual machine with CPU usage below 10% and memory usage below 10%.

10. The method of claim 9, wherein restricting, by the security module, access includes updating an access policy of the virtual machine to limit interaction to privileged entities only.

11. A method for managing virtual machines in a distributed cloud environment using discrete time simulation, the method comprising:
initializing, by a discrete time simulation (DTS) framework, a system including a virtual machine registry, a snapshot repository, and telemetric devices;
configuring, by the DTS framework, the telemetric devices to monitor hardware parameters of a virtual machine by connecting each telemetric device to the virtual machine and starting real-time monitoring of the hardware parameters;
processing, by a data fusion processor of the DTS framework, data fusion for the virtual machine by consolidating event logs, application heuristics, and telemetry data into fused data, aggregating the event logs from multiple sources, and extracting trends from the application heuristics;
analyzing, by a system parameter analyzer of the DTS framework, temporal evolution of system parameters including CPU usage, memory usage, and GPU usage based on the fused data;
predicting, by a prediction engine of the DTS framework, future resource needs of the virtual machine over a time interval using the system parameters and extrapolating the system parameters to estimate a number of additional virtual machines required for the distributed cloud environment;
generating, by a snapshot generator of the DTS framework, a snapshot for the virtual machine by auto-coding instructions based on software requirements, project versions, and a configuration template specific to a deployment lane, the auto-coding instructions being produced in a programming language compatible with a target cluster;
deploying, by a deployment module of the DTS framework, the snapshot with metadata to a centralized repository and the target cluster in the distributed cloud environment by uploading the snapshot to the centralized repository and executing the auto-coding instructions in the target cluster with a single command;
forecasting, by a prognosis utility of the DTS framework, a future operational state of the virtual machine based on the fused data, including generating a 30-day forecast and assessing risks based on current system parameters;
monitoring, by a health monitoring utility of the DTS framework, a health status of the virtual machine by comparing the system parameters to predefined thresholds, including checking the CPU usage against an 80% threshold, the memory usage against a 90% threshold, and the GPU usage against an 85% threshold;
maintaining, by a maintenance utility of the DTS framework, the virtual machine by executing actions when the health status exceeds the predefined thresholds;
diagnosing, by a grid diagnostic module of the DTS framework, unused grids in the virtual machine by identifying low CPU and memory usage, specifically identifying the virtual machine with CPU usage below 10% and memory usage below 10%;
restricting, by a security module of the DTS framework, access to the unused grids to privileged entities by updating an access policy of the virtual machine to limit interaction to privileged entities only;
repeating, by the DTS framework, the processing, predicting, generating, deploying, forecasting, monitoring, maintaining, diagnosing, and restricting steps periodically to manage the virtual machine dynamically;
storing, by the DTS framework, the fused data and snapshots in a distributed repository across multiple geographic regions; and
integrating, by the DTS framework, the deployment module with an external cloud orchestration tool to deploy the snapshot into a containerized environment.

12. A system for managing virtual machines in a distributed cloud environment using discrete time simulation, the system comprising:
a discrete time simulation (DTS) framework that initializes a virtual machine registry storing virtual machine data, a snapshot repository storing snapshots, and telemetric devices monitoring hardware parameters;
a plurality of telemetric devices that monitor hardware parameters including CPU usage, memory usage, and GPU usage of a virtual machine in real time;
a data fusion processor, within the DTS framework, that consolidates event logs, application heuristics, and telemetry data from the telemetric devices into fused data for the virtual machine;
a system parameter analyzer, within the DTS framework, that analyzes temporal evolution of system parameters including the CPU usage, the memory usage, and the GPU usage based on the fused data;
a prediction engine, within the DTS framework, that predicts future resource needs of the virtual machine over a time interval using the system parameters;
a snapshot generator, within the DTS framework, that generates a snapshot for the virtual machine by auto-coding instructions based on software requirements, project versions, and a configuration template specific to a deployment lane;
a deployment module, within the DTS framework, that deploys the snapshot with metadata to a centralized repository and a target cluster in the distributed cloud environment;
a prognosis utility, within the DTS framework, that forecasts a future operational state of the virtual machine based on the fused data;
a health monitoring utility, within the DTS framework, that monitors a health status of the virtual machine by comparing the system parameters to predefined thresholds;
a maintenance utility, within the DTS framework, that maintains the virtual machine by executing actions when the health status exceeds the predefined thresholds;
a grid diagnostic module, within the DTS framework, that diagnoses unused grids in the virtual machine by identifying low CPU and memory usage;
a security module, within the DTS framework, that restricts access to the unused grids to privileged entities; and
a scheduler, within the DTS framework, that periodically activates the data fusion processor, the prediction engine, the snapshot generator, the deployment module, the prognosis utility, the health monitoring utility, the maintenance utility, the grid diagnostic module, and the security module to manage the virtual machine dynamically.

13. The system of claim 12, wherein the plurality of telemetric devices connects to the virtual machine and starts real-time monitoring of the hardware parameters upon configuration by the DTS framework.

14. The system of claim 13, wherein the data fusion processor aggregates the event logs from multiple sources and extracts trends from the application heuristics to produce the fused data.

15. The system of claim 14, wherein the prediction engine extrapolates the system parameters to estimate a number of additional virtual machines required for the distributed cloud environment.

16. The system of claim 15, wherein the snapshot generator produces the auto-coding instructions in a programming language compatible with the target cluster.

17. The system of claim 16, wherein the deployment module uploads the snapshot to the centralized repository and executes the auto-coding instructions in the target cluster with a single command.

18. The system of claim 17, wherein the prognosis utility generates a 30-day forecast of the future operational state and assesses risks based on current system parameters.

19. The system of claim 18, wherein the health monitoring utility checks the CPU usage against an 80% threshold, the memory usage against a 90% threshold, and the GPU usage against an 85% threshold to determine the health status.

20. The system of claim 19, wherein:
the grid diagnostic module identifies the virtual machine with the CPU usage below 10% and the memory usage below 10% to diagnose the unused grids;
the security module updates an access policy of the virtual machine to limit interaction with the unused grids to privileged entities only;
the scheduler activates the data fusion processor, the prediction engine, the snapshot generator, the deployment module, the prognosis utility, the health monitoring utility, the maintenance utility, the grid diagnostic module, and the security module on an hourly basis;
the DTS framework stores the fused data and the snapshots in a distributed repository spanning multiple geographic regions to reduce latency; and
the deployment module integrates with an external cloud orchestration tool to deploy the snapshot into a containerized environment compatible with the distributed cloud environment.
